(19) United States
(12) Patent Application Publication
(10) Pub. No.: US 2007/0174777 A1
(43) Pub. Date: Jul. 26, 2007

(54) Three dimensional graphical user interface representative of a physical work space

(76) Inventors: William Derek Finley, Ottawa (CA); Christopher William Doylend, Ottawa (CA)

Correspondence Address: FREEDMAN & ASSOCIATES, 117 CENTREPOINTE DRIVE, SUITE 350, NEPEAN, ONTARIO, K2G 5X3, omitted

(21) Appl. No.: 11/698,153

(22) Filed: Jan. 26, 2007

Related U.S. Application Data
(60) Provisional application No. 60/762,128, filed on Jan. 26, 2006.
(60) Provisional application No. 60/762,514, filed on Jan. 27, 2006.

(51) Int. Cl. G06F 17/00

(52) U.S. Cl. 715/734

(57) ABSTRACT

A user interface supporting a virtual three dimensional virtual environment is described. The virtual environment supports representations of actual computer hardware and user interaction with the representation is optionally used to control the corresponding computer hardware. Similarly, interactions with the computer hardware are optionally shown by the representations of the hardware within the virtual environment.

### FIELD OF THE INVENTION

This application claims benefit from U.S. Provisional Patent Application No. 60/762,128 filed Jan. 26, 2006 and No. 60/762,514 filed Jan. 27, 2006.

The present invention relates to User Interfaces and more particularly to a method and system for providing a user interface operable for applications including operating systems.

### BACKGROUND OF THE INVENTION

Data access and retrieval has always been an important aspect of computers. Different data retrieval and data display models have been proposed over the years, but most system designers return to one of three methods due to their simplicity, ease of use, and user comprehensible models. These three models include the desktop model, the list based model, and the hierarchical list model.

The desktop model popularized by Apple® with its Macintosh® computers is used to display computer operating system data in a virtual desktop. On a computer screen is shown an image of a desktop with files, applications, a trash can, and so forth. Access to files is achieved by selecting icons and opening files/folders associated therewith to reveal either further files or to access the file so opened. Though the model is convenient, it is often difficult to use due to system level constraints. For example, Windows® a popular operating system provided by Microsoft® has limitations on file name length and, as such, is sometimes unable to store files sufficiently deeply within nested folders to truly reflect the desktop based model. Further, since some systems are more limited than others, the model when implemented results in some limitations on portability. For many applications and for application execution, the desktop model is often poor.

Also, though the desktop model is well suited to providing user references for many different functions, it is poorly suited for organizing large volumes of data since it has no inherent organizational structure other than one set by a user. Thus, similar to actual physical desktops, some virtual desktops are neat and organized while others are messy and disorganized. Thus, for data organization and retrieval, the virtual desktop model is often neutral—neither enhancing nor diminishing a user's organizational skills.

The list-based model is employed in all aspects of daily life. Music organization programs, display music identifiers such as titles and artists in a list that is sortable and searchable based on many different criteria. Typically, sort criteria are displayed as column headers allowing for easy searching based on the column headers. Many applications support more varied search criteria and search definition.

Another example of list based data display is Internet search engines, which typically show a list of results for a provided search query. The results are then selectable linking the user to a World Wide Web Site relating to the listed result. Unfortunately, with the wide adoption of the World Wide Web and with significant attempts to get around search engine technology—to “fool” the search engines—it is often difficult to significantly reduce a search space given a particular query. For example, the search term “fingerprint” returns a significant number of results for biometric based fingerprinting similar to that used by police and a significant number of results for genetic fingerprinting using DNA. These results are distinct one from another.

The hierarchical list is similar to the list-based model but for each element within a higher-level list, there exist further sub-items at a lower level. Thus, a first set of folders allows for selection of a folder having within it a set of subfolders, etc. This allows for effective organization of listed data. In the above noted music list program example, classical music can be stored in a separate sub list from country music.

Unfortunately, the desktop model, which has been beneficial to the widespread acceptance of personal computers generally, is often insufficient for effective organization of data and applications within organizations, distributed environments and handling large amounts of information. It would be highly advantageous to provide a graphical user interface that is better suited to these users needs and supports both simple navigation and utilization.

### SUMMARY OF THE INVENTION

An embodiment of the invention teaches a method comprising: providing a computing device comprising a user input port, a display and a data communication port; providing image data to the display, the image data supporting a user interface that provides images in corresponding to a three dimensional virtual environment; providing a peripheral device in data communication with the computing device via the data communication port; providing a virtual representation of the peripheral device within the three dimensional virtual environment; receiving an input signal from a user via the input port, the input signal indicative of user interaction with the virtual representation of the peripheral device; providing data to the peripheral device in accordance with the input signal.

Embodiments of the invention also support a computing device comprising: a memory for storing data, at least a portion of the data relating to a three dimensional virtual environment and selectable elements provided within the three dimensional virtual environment; a user input device for receiving user input signals, the user input signals corresponding to a movement of a viewpoint and selection of elements within the three dimensional virtual environment; a data communication port in communication with a peripheral device, the data communication port for receiving peripheral device data; a processor for generating image data in dependence upon the three dimensional virtual environment, the viewpoint and the peripheral device data; and, a display for displaying the image data.

### BRIEF DESCRIPTION OF THE DRAWINGS

Exemplary embodiments of the invention will now be described in conjunction with the following drawings, in which similar reference numerals designate similar items:

FIG. 1A is a simplified diagram of a prior art graphical user interface;

FIG. 1B is a simplified diagram of a prior art graphical user interface, when the user is seeking to access an application rarely used;

FIG. 2A is a simplified diagram according to a first embodiment of the invention, showing a first view of the users virtual workspace as modeled after a typical office;

FIG. 2B is a simplified diagram according to a first embodiment of the invention, showing a second view associated with another viewpoint of the user within their office environment;

FIG. 2C is a simplified diagram according to a first embodiment, showing a third view associated with another viewpoint of the user within their office environment;

FIG. 3 is a simplified diagram according to a second embodiment, wherein the user has established shortcuts or aliases onto the virtual desktop;

FIG. 4A is a simplified diagram corresponding to a third embodiment, wherein the user has multiple monitors, and shows a first virtual desktop image provided on the first monitor; and

FIG. 4B is a simplified diagram corresponding to a third embodiment, wherein the user has multiple monitors, and shows a second virtual desktop image provided on a second monitor.

### DETAILED DESCRIPTION OF EMBODIMENTS OF THE INVENTION

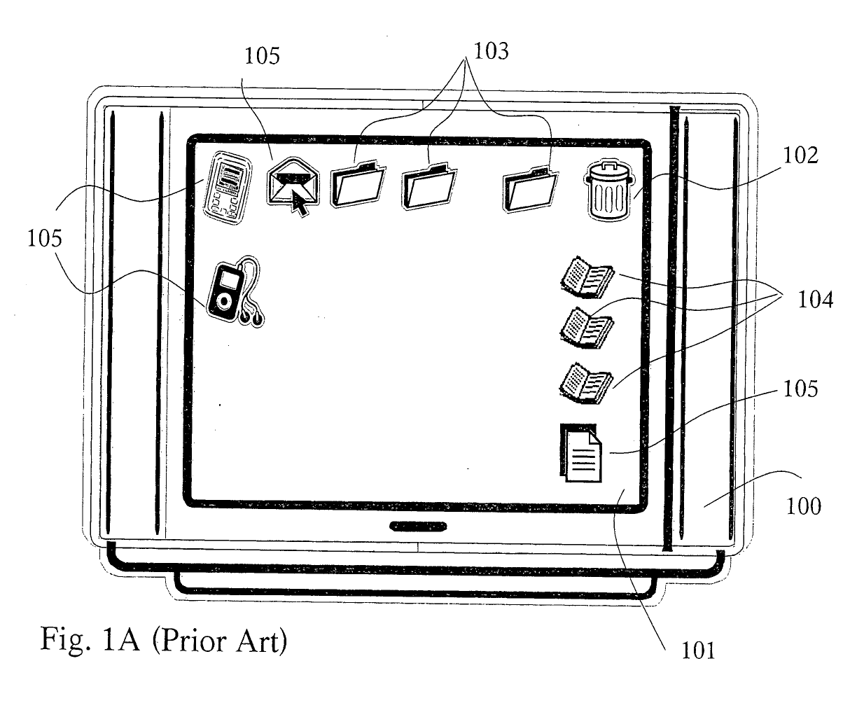

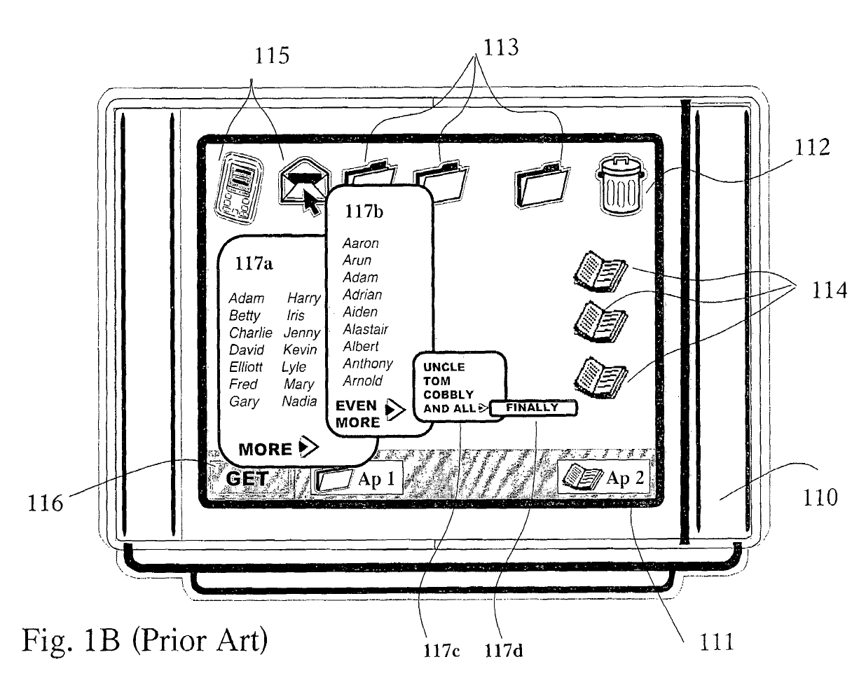

Referring to FIG. 1A, shown is simplified representation of a prior art graphical user interface, such as the Windows® based operating system. This user interface is very similar to one developed over twenty years ago and popularized by Apple® Computers. As discussed above, the graphical user interface models a desktop display 100, having a virtual desktop 101 with a recycle bin 102, folders 103, files 104, and applications 105 available thereon. Such a graphical user interface is well known. Further, the graphical user interface (GUI) provides convenient access to delete files and to those files deleted via the recycle bin.

Clearly, the prior art GUI represents a simple model for finding those items that are well organized; however, in many cases, the location of specific information is not presented in an intuitive way. Thus, a worker optionally organizes their virtual desktop 101 in a fashion that they can efficiently navigate; unfortunately, not all workers are so organized. Specifically, a worker with a disorganized desktop is likely to have a disorganized virtual desktop 101. As such, many individuals with an “out of sight out of mind” attitude have a desktop that is cluttered and filled with files and folders and applications. Equally the prior art GUI rapidly becomes cluttered and difficult for even an organized and methodical worker active on a large number of documents and applications.

Unlike a true desktop which is within an office, the desktop is much more difficult to organize effectively and intuitively. For example, the background of the desktop, intended to be pleasing to look at, is covered and cluttered by anything on the desktop. Other folders are difficult to intuitively arrange. Further, cleaning of the desktop and folders results in reorganization of all the files and folders, which is often undesirable. Further, one method of organization is different from another and the though the interface is intuitive in some ways, it is not intuitive in many others and, as such, someone else will have difficulty locating files, folders and applications.

Referring to FIG. 1B, shown is a typical prior art graphical user interface of a Windows® based operating system when the user is seeking to access an application rarely used. Again this interface is very similar to one developed over twenty years ago and popularized by Apple® Computers. Shown is the desktop display 110 on which the graphical user interface has again recreated the typical virtual desktop 111. As previously shown this has graphical user icons for a recycle bin 112, folders 113, files 114, and applications 115 available thereon. Such a graphical user interface is well known.

Also shown is the bottom toolbar 116 which typically displays icons for open applications 115, folders 113 and files 114 alongside other items according to the users settings which may include, but are not limited to, clock, virus protection, network availability etc (which are not shown for clarity). The graphical user interface provides quick and convenient access to applications and files located on the desktop. For files and applications that are less often accessed or that require greater organization, folders are nested one within another to provide for organized storage of data and applications.

In order to overcome this problem, Microsoft® has added a Start® button to the Windows® user interface providing access to applications, settings and to recent documents. This is shown in FIG. 1B in the form of the first application menu 117a, which upon selecting certain elements within the first application menu leads to second menu 117b featuring a refined subset of the applications, for example a list of software providers. This in turn may lead to a third menu 117c, for example the list of loaded applications from the selected software provider, and as shown to finally a fourth menu, 117d, which following the example of software applications might list the application, its help file, its subscription or license, uninstall and provider link. Obviously, many other such menu options exist and are known to those skilled in the art.

Thus, a feature outside of the desktop paradigm is needed to provide convenient functionality of the “intuitive” user interface.

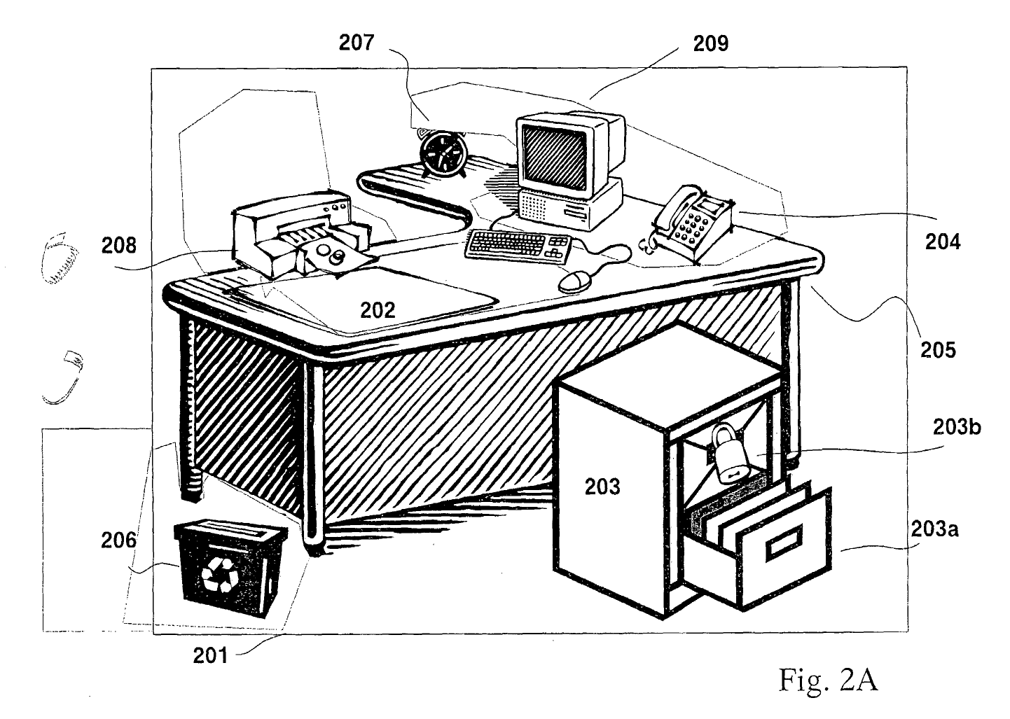

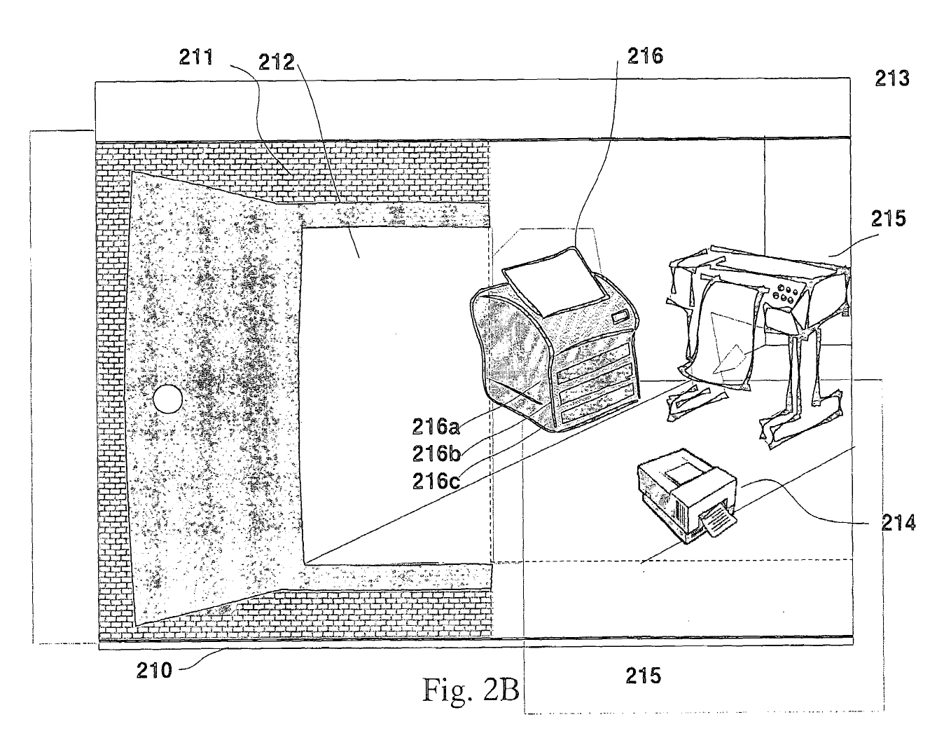

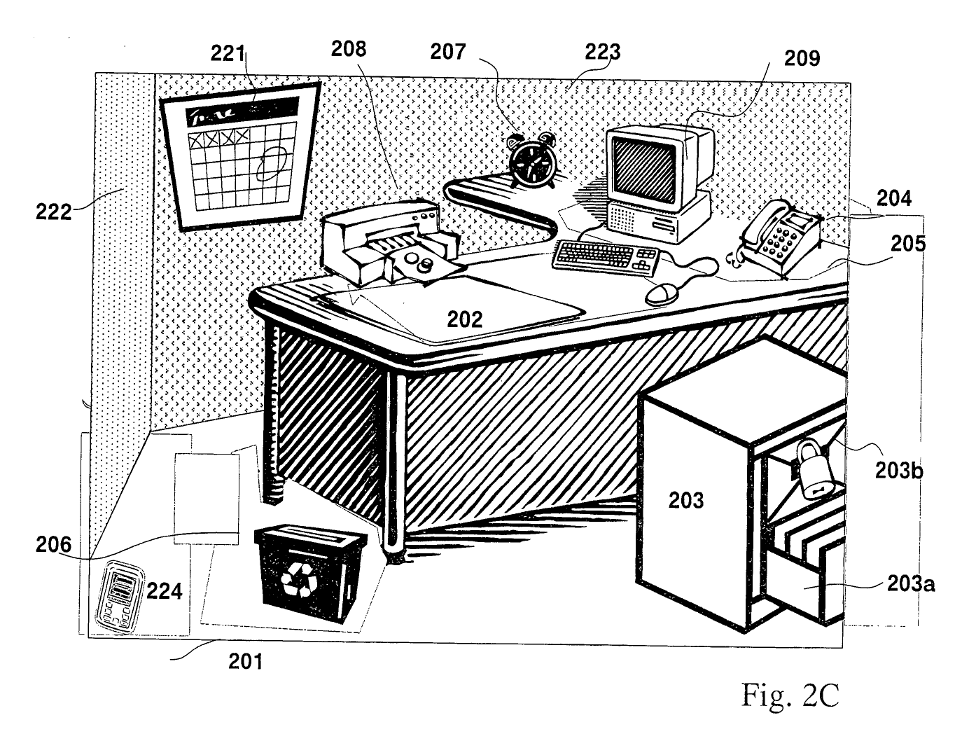

Referring to FIG. 2A, shown is a simplified diagram according to a first view of a first embodiment of the invention. Shown is a simplified image representing a first view of the user's virtual workspace 201 as modeled after a typical office. The virtual workspace 201 as displayed includes a virtual desk 205, which comprises a virtual desktop element 202 and personal computer 209. Also shown are a virtual filing cabinet 203 and, a virtual telephone 204. Further, a virtual recycle bin 206, a virtual alarm clock 207, and a virtual printer 208 are within the virtual space 201.

As is evident to those of skill in the art, a user interface based on the virtual space provides a two-dimensional view of a portion of the space—a viewport. Navigation tools may allow a user to navigate throughout the space in order to change their current viewport. For example, during typical work, a user sets the viewport to the virtual desktop 202 of their virtual desk 205. In use, the virtual desktop 202 provides much of the functionality of the prior art graphical user interface 101, and mimics their normal actions when working with documents, files and folders on a real physical desk. It is therefore very familiar and simple to use for the user. Thus the virtual desktop 202 supports providing files and folders as well as access to frequently used applications. For example, selecting a blank lined pad of paper triggers the loading of a document generation application. Also, like the prior art virtual desktop 101, the virtual desktop 202 according to the invention supports conventional functions for opening and otherwise manipulating files and folders in a fashion consistent with the prior art.

To access an existing, but currently unopened file, the viewport is redirected to the file cabinet 203. The virtual file cabinet 203 functions in a fashion consistent with a real filing cabinet but with the added functionalities provided by electronic data storage such as search and retrieval, indexing, correlated data, time stamped data, and so forth. In this case the file cabinet is shown with two drawers, 203a and 203b, and may be labeled for ease by the user with their references much like a real physical cabinet. Optionally, as shown a file drawer 203a is shown locked, but it could also be the whole file cabinet 203. If the user within the virtual desktop goes to extract from the locked file drawer 203a then the user is prompted to provide authorization data prior to access thereto. Alternatively, for filing cabinets that are not locked, such as 203b these open files/folders are displayed in a manner predefined by the user.

The virtual telephone 204 supports telephone services using a virtual telephone interface. Alternatively, the virtual telephone 204 supports telephone services using a real telephone supporting a data connection with a computing device that supports the virtual environment. When the user provides an appropriate input signal to the virtual telephone 204 a telephone interactive application is optionally launched. Alternatively, the application is a terminate stay resident application, a constantly available application in execution, or functions of the application are executed from the graphical user interface which is in common execution. This application facilitates the use of telephone functions such as address book look-up, three-way calling, call waiting, message center, and so forth.

The virtual workspace 201 is a virtual three-dimensional environment. The virtual workspace 201 supports commands that allow a user to change the location of and orientation of their viewpoint within the virtual workspace. Thus, while one would expect to use the virtual desktop 202 frequently, in situations where the viewpoint of the user is not directed to the virtual desktop 202, the virtual desktop 202 need not be shown.

Referring to FIG. 2B shown is a second view presented to a user in a first embodiment of the invention. Shown is a simplified image associated with another viewpoint of the user within their office environment. In this figure the characteristics of other assets associated with a real office environment are represented in the virtual workspace 210. For example, a worker is located in an office, shown by the wall 211 and door/doorway 212 which is connected to a short hallway 213. Shown within the hallway are three printers, 214, 215, and 216. Each of the printers has a specific function. For example, printer 214 is for printing detailed drawings on oversized paper, printer 215 is dedicated for printing legal documents on 8.5″ by 14″ paper while the third printer 216 is for printing on European A4 sized paper. Using the prior art system, a user printing a document would be requested to choose a printer from a list or a printer is chosen by default. If the user is requested to select a printer it is likely that the user will be provided with simply a list of printers, and their network identities. In some cases additional information accessible to the user is little more than a name of the manufacturer and a part number. This description is often insufficient and in many cases, even if the user knows which printer they want the user will be asked to specify which tray the printer is to use. For some centralized networked printers this can easily be selecting from four or more trays each with potentially different printing media, paper, transparencies, labels etc as well color, orientation, size, etc. Using the prior art system, as described with reference to FIG. 1, a user would likely select a printer by going down the hall, inspecting the printers and committing a printer identifier, such as a part number, to memory. In contrast, using the system according to the first embodiment of the invention, the user changes their viewpoint to the location down the hallway and the user is presented with an image comprising information associated with each of the printers.

By adjusting the viewpoint, the virtual desktop 202 is likely to no longer be provided in the field of view. Optionally, the user is provided an icon that automatically, and rapidly, returns their viewpoint to a predetermined location such as the virtual desktop 202. Alternatively, the user returns to a specific viewpoint when a specific input signal is provided. Thus, for example, by touching a monitor for five seconds, the viewpoint is automatically returned to a default position. Further optionally, the user is provided the option of producing an icon that changes the viewpoint to a predetermined location specified by the user.

In order to convey useful information, the printers 214, 215 and 216 in the image 210 are shown having a size that is consistent with their actual size. In addition, those printers, for example 216, that have a multitude of trays for providing paper are shown supporting a corresponding set of trays, 216a to 216c. Optionally, other data regarding the trays, such as paper size and default paper color are provided. The user is then able to inspect the printers and make their choice between the real printers by selecting the image corresponding to the printer. In this way, the user is provided information consistent with the actual printers without having to physically move to the printers to acquire that information.

Similarly, with reference to FIG. 2A, the user wishing to call a coworker is able to select their own virtual telephone 204 and displace their viewpoint to the virtual desk of a colleague and select the virtual telephone of the colleague. Once this is done, the user activates their real telephone and the telephone of the colleague is rung automatically. Alternatively, a voice connection is effected via the computers of the two users via the data communication network. Optionally, the virtual telephone of the colleague is shown with the receiver off the hook to indicate that the telephone of the colleague is already in use. The user is then provided with a list of telephone options, for example, the user optionally provides a voice mail, or, alternatively, the user requests to be provided a prompt when the telephone of the colleague is no longer in use, or the user is provided the option to connect with a colleague at a desk adjacent to the one the user is trying to contact so that he can ask for them to take an urgent call. A person of skill in the art will appreciate that a wide variety of services are optionally supported.

The first embodiment of the invention acts to provide information to a user in a fashion that is consistent with how a user would normally acquire corresponding information in the physical world. In addition, the user is provided an interactive system that is functionally consistent with a real system. This consistency reduces the amount of training necessary for most users to learn a new system. Further still, the embodiments of the invention support the use of relatively complex services, such as telephone services, via the virtual environment with minimal training in the use of those services. Finally the addition of supportive hardware such as eye-tracking or head-tracking software would further add to the consistency with a real world environment as the system could react to natural behavior of the user rather than requiring keyboard, mouse or other pointer device inputs to control the viewpoint and functions.

In order, to support the functionality of the virtual environment, supporting devices optionally provide interface data useable by a computing device generating the virtual environment. Thus, for example, when a new printer is installed in the working environment and said printer provides suitable data communication with the computing device that provides the virtual environment, the virtual environment is optionally updated to indicate a virtual representation of the new device. Similarly, when a device is no longer in a state of suitable data communication, it is no longer represented within the virtual environment. Alternatively, such devices are shown as non-functional in the virtual environment when suitable data communication is not available.

Expanding upon this FIG. 2C shows a slightly different view of the same workspace as FIG. 2A, and now shown in the virtual workspace 201 is a virtual calendar 221 on a virtual wall 222. A user is able to position the virtual calendar at will within a predetermined region of the virtual environment, say always on a wall such as either the sidewall 222, or as shown the back wall 223. Optionally, the virtual location of the calendar is not limited to a subset of the virtual workspace 201 and hence might be displayed irrespective of the user viewpoint. Thus, a user is optionally provided a virtual office and virtual items within the virtual office.

Certain virtual items located outside the virtual office of the user do not support interaction with the user. In this way, large and complex virtual workspaces with many distinct users are optionally supported. Considering the calendar the user can now advantageously provide notes to the calendar including reminders, have documents distributed for a meeting linked to the meeting notice on the calendar so that retrieving them is quick, and also automatically have these updated as different releases of documents, such as the meeting agenda, are distributed. In addition, the calendar is optionally used to open a personal scheduling program that supports substantially more detail than a conventional calendar would. Some events are optionally provided to the calendar automatically. Further, by placing of files in front of calendar events, etc. it is possible to organize data in a temporal fashion as well as in a special fashion.

Optionally, a person who has a personal digital assistant (PDA) or sophisticated email pager and cellular telephone has a virtual PDA shown in their virtual workspace 201. If the user has the PDA undocked from its docking station then the user can have the system maintain an icon for the PDA in any viewport the user subsequently assesses in a predetermined position, see for example 224 in FIG. 2C where the PDA icon is displayed in the lower left corner.

By activating the virtual PDA, real PDA functions are controlled. Thus, the user easily transfers data, updates schedules etc. between the PDA and the virtual workspace 201. In addition communication between the PDA and the users computer 209 is optionally controlled, for example by providing an input signal within the virtual environment. Consider for example, the virtual PDA is optionally brought into close proximity with the virtual calendar. In response to this proximity, a predetermined function is carried out supporting, for example, the synchronization of a scheduling system in the PDA with a scheduling program of the computer. Upon completion of this task the PDA icon returns to a predetermined location.

In the case of a PDA, it is possible to advantageously add additional functions such as denoting where a colleagues' PDA is, for example using wireless assisted GPS. Hence, when needing to quickly meet a colleague to discuss something the user can locate them rather than hunting them randomly within the working environment. Equally the system could determine when the real PDA is determined to be in a predetermined location within, for example, an office, or outside of the office, and hence indicate that said colleague is out of the office automatically when the user selects this colleague on the virtual telephone.

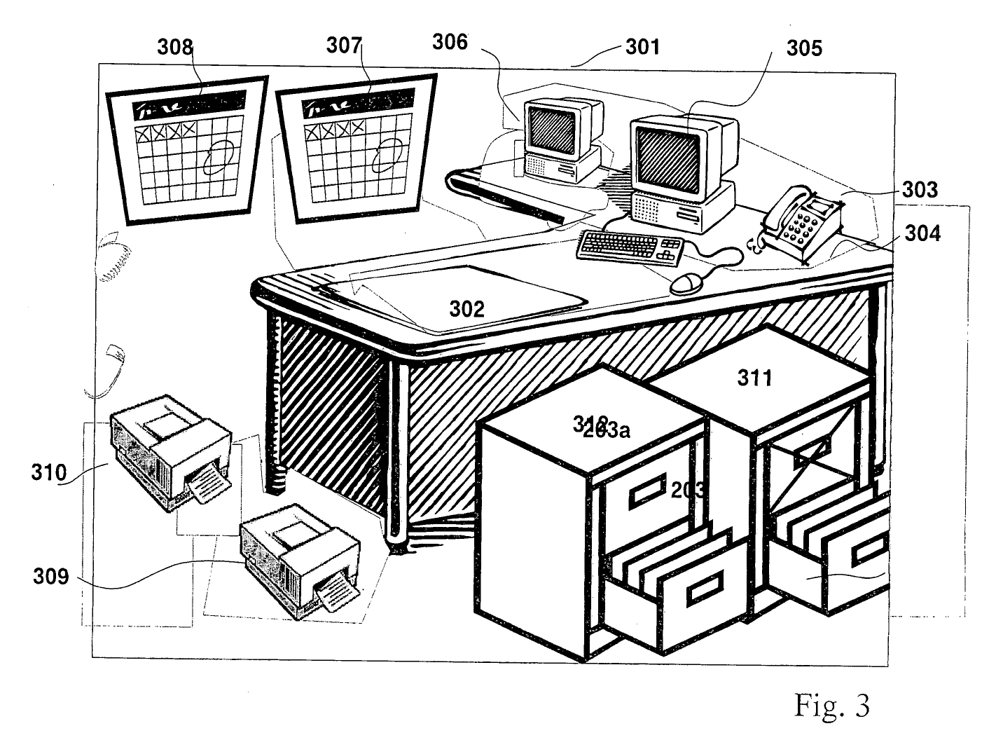

Referring to FIG. 3 shown is a second embodiment wherein the user has established shortcuts or aliases onto the virtual desktop. Shown is a virtual desktop 301 upon which the user has merged shortcuts or aliases for items, which may be external to their immediate environment but are frequently accessed or utilized. As such the virtual desktop contains the users virtual desktop 302, their virtual telephone 303, virtual desk 304, their virtual personal computer 306, their virtual calendar 307 and personal filing cabinet 311.

Additionally the user has added shortcuts as follows:

virtual computer 305, which for example could be a server that the user is responsible for maintaining, a remote computer within a laboratory performing tests under the users direction, or a variety of other advantageous links to additional computers;

second virtual calendar 308, which for example could be the merged vacation records for the users team, bookings for a conference room the user is responsible for, or a variety of other advantageous links to additional calendars;

a virtual printer 309, which for example might be the printer in the printing room of a design company, a printer at a colleagues desk in a remote facility, or a range of other advantageous uses of a link to a remote computer;

a second virtual printer, which for example might be the printer of the central sales office wherein the user can print orders from his satellite office;

a second virtual filing cabinet 312, which for example may be central personnel records, accounting or other such centralized records, which would normally be managed through complicated links to multiple servers and/or directories.

In this manner the user optionally customizes their virtual desktop to reflect their actual operating requirements. It would be evident therefore to one skilled in the art that this embodiment, and others provide for an increased efficiency of an employee's time and resources, and provides for organization of a users environment at many levels, rather than the single uniform structure of a conventional desktop operating system, GUI, and software environment.

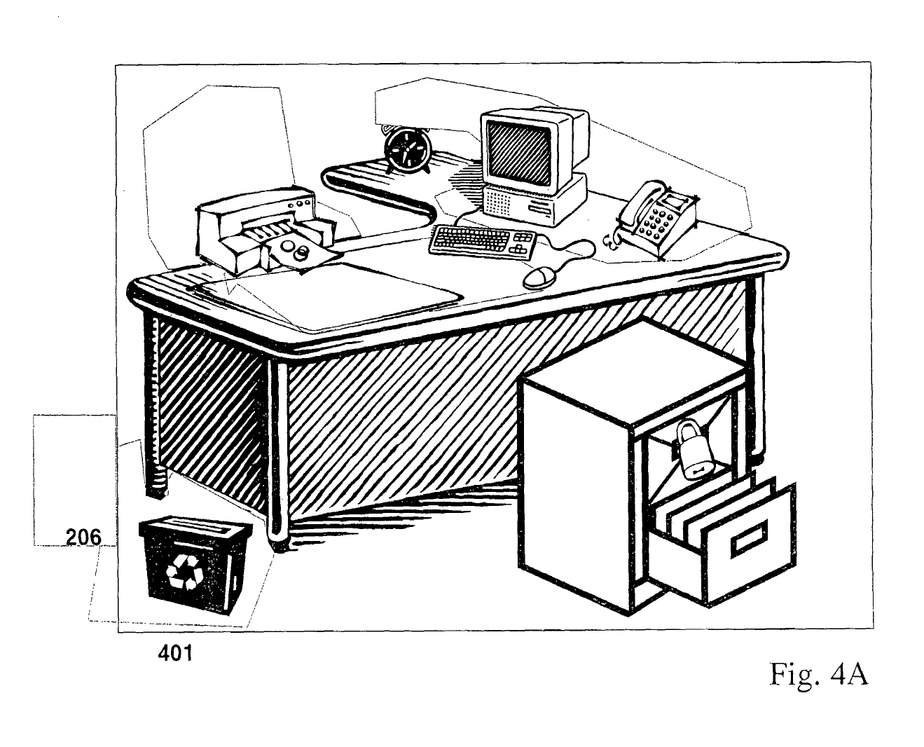

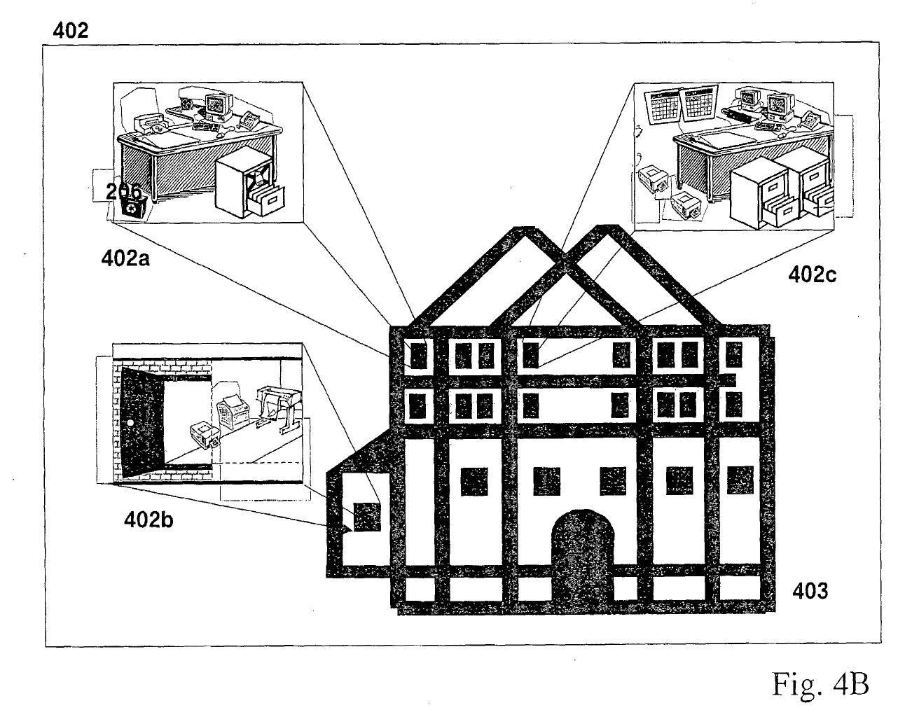

Referring to FIG. 4A and FIG. 4B shown is a third embodiment wherein the user is now able to leverage the virtual desktop with multiple monitors. Shown in FIG. 4A is a simplified diagram corresponding to a first virtual desktop image 400 provided on a first monitor. Referring to FIG. 4B a simplified diagram corresponding to a second virtual desktop image 402, this second virtual desktop image 402 being displayed on a second physical monitor. In the embodiment described herein the view provided on the first monitor is responsive via an input signal associated with the second monitor and the users actions on the said monitor in defining a view. Alternately, the two images may be completely decoupled with one monitor being the personal desktop of the user and the second monitor being a view of an overall manufacturing environment wherein the users viewport on this second monitor adjusts according to their actions on said second monitor.

Thus, for example, a user stores a set of icons 402a to 402c on the virtual desktop of the second monitor. The icons 402a to 402c representing viewpoints of three different locations within a physical building which is denoted in the virtual desktop image by the building 403. A first icon 402a corresponds to a predetermined viewpoint of the virtual environment. By interacting with the icon 402a, an image associated with the viewpoint is shown in first monitor. Clearly, the first monitor is optionally used for other functions. For example, the first icon 402a links the user to a viewport associated with their own desktop allowing them to perform their normal desktop actions.

The second icon 402b corresponds to a predetermined viewport of a manufacturing environment. In selecting this icon the viewport on the first monitor adjusts to reflect the selected viewport. This for example might allow the user to adjust the operation of manufacturing machines, check the status of manufacturing schedules, and look at inventory or a variety of other advantageous actions from their desk. In the embodiment considered here the user is able to manipulate the viewpoint of either monitor. In addition, the viewpoint in both monitors is optionally changed in response to a same input signal.

Finally, the third icon 402c corresponds to a predetermined viewport of the corporate headquarters. In selecting this icon the viewport on the first monitor adjusts to reflect the selected viewport. This for example might allow the user to work on centralized manufacturing, quality, and financial records as opposed to their personal localized files, which are managed through their personal virtual desktop access through icon 402a.

Within the embodiment as described it is possible to adjust the users ability to manipulate their virtual desktops as accessed through the different icons 402a, 402b and 402c. This can provide a different approach to security as for example a clerk might only be able to access a virtual desktop, which is fixed and predetermined. A supervisor may be able to adjust to some degree the virtual desktop, for example to reflect their teams locations, operations and even accessing additional resources above and beyond those available to the clerk, for example a printer or external networks.

It may also be beneficial in some instances that the viewports 402a to 402c are not predetermined but can be changed according to the user selecting a room within the image presented of the building 403. Hence, the image of the building 403 might be a floor plan and selecting a room causes a virtual desktop icon to appear on the second monitor, which can then be selected and worked with on the first monitor. In this manner for example a user can work on a presentation, then select a meeting room, schedule a meeting, invite attendees, and finally store the presentation on the projection system within the meeting room.

It may also be beneficial in some instances and embodiments of the invention for certain virtual elements to remain consistent within the computer interface and hence denote some virtual elements are designated as being fixed, whereas others are not fixed. Thus, it is possible in other embodiments of the invention to allocate additional properties to elements of the virtual desktop providing for unforeseen advantages in the efficiency and operational effectiveness of the users accessing the virtual desktops.

Hence, for example, one of the shared printers that has a physical presence at the end of the hallway, as described previously in FIG. 2A. The printer stays in this location. A virtual printer indicative of the physical printer may be designated as fixed and therefore, a user is unable to move it in the virtual environment. Alternatively the printer is not fixed, and the user is able to move it in the virtual environment, even onto his or her own personal virtual desktop. The printer may therefore actually possess different properties to different users, an example of which being one user can only access the top tray of the printer, which contains normal paper. However, a second user accesses the top and bottom trays of the printer, wherein the second tray contains cheques, which can be printed by the second user in response to their actions on the desktop of working on accounts payable for instance.

Clearly, there are other virtual items within the virtual environment, which are mobile, and permanently moveable by any user. Consider, for example, in a work environment where any worker is available to do piece work, and a set of work orders are provided on a virtual bulletin board. A virtual presence of a worker is able to review the work order and, should the worker decide to do work of one specific work order transfer the work order off the virtual bulletin board to say a virtual inbox for that worker. The workers supervisor being able to see both the virtual bulletin board and the inboxes of all workers can therefore manage the workers and work flow within the work environment.

In an alternative embodiment of the invention, the interaction of a user within a virtual environment is the manipulation of real devices, as well as the manipulation of documents, text etc. For example, a user optionally integrates the lighting system of their office within the virtual workspace displayed upon their selection of icon 402a in the third embodiment of the invention. The lighting system is designed to be responsive to input signals provided by a designated computing device. Thus, a user interacting with their virtual desktop and toggling a switch within the virtual environment causes the appropriate signal to be communicated to the designated computing device handling lighting and therein turn on or off their office lights. It would be appreciated to one skilled in the art that alternate embodiments are possible wherein the virtual desktop adjusts to reflect the users actions, and in this case for example brighten the desktop to respond to lights turning on or “turn on a virtual light bulb”. In this manner the virtual desktop can change in visual presentation to the user allowing the current environment to be accurately reflected.

Clearly, other embodiments are easily envisioned in which a user manipulates a virtual item to achieve a real response. For example, in a manufacturing environment a set of machines perform a set of predetermined tasks. A virtual environment associated with the manufacturing environment is provided. A real inspection station inspects manufactured items for defects. A user is able to provide a virtual input signal to an inspection device to provide a specific view of an item in inspection. If the item undergoes a cleaning operation prior to inspection but the inspected item is not clean, the user optionally changes their viewpoint to a cleaning station. The user is then provided image data from the cleaning station. The user optionally changes parameters associated with the cleaning station by providing input signals to the virtual environment. These changes result in corresponding changes to the cleaning process. Clearly, in such an embodiment of the invention it would be beneficial to provide a relatively large number of monitors such that plurality of different stations are optionally viewed at a given time. Alternatively, a given monitor supports a plurality of different viewports.

In another aspect of the invention, the user wishes to extract a document from their filing cabinet, which has two drawers. Much like the real physical world the virtual desktop can display the names of the drawers, say General and Confidential. The user clicks on the filing cabinet drawer marked Confidential, which is shown as locked. Upon providing the correct verification of the users identity, which can be from a variety of means including and not limited to the direct entry of security data, connection of a USB security dongle with automatic verification, and even biometric data, the drawer opens to display a series of files. In this case the files are visually indicative of their contents, which optionally include degree of sensitivity of materials stored, number of records within the file, memory space consumed or many other predetermined settings.

The user selects the appropriate file, which opens, and now in this embodiment and unlike an existing desktop solution, the system presents the records firstly according to predetermined preferences. These for example could be to present all graphical images as if in a picture album but now with each page having additional notations such as originator, date, contents etc. For written documents the presentation could be as a library with filenames displayed on the spines, or a folder with the title pages for leafing through much like a photo album. The system could allow the user to shift views should they experience difficulty or even call up search tools. As such these embodiments leverage the human attributes of sight and memory in manners closest to our real world experiences and normal behavioral patterns, rather than those determined by a desktop software company with long lists of similar names, sorted alphabetically or historically rather than contextually etc.

Though the term peripheral device is used herein with relation to computer peripherals such as printers, it is also envisaged that external sensors, monitors, or other peripheral devices are included within the scope of the term peripheral.

Numerous other embodiments may be envisioned without departing from the spirit and scope of the invention.

What is claimed is:

1. A method comprising:
providing a computing device comprising a user input port, a display and a data communication port;
providing image data to the display, the image data supporting a user interface that provides images corresponding to a three dimensional virtual environment;
providing a peripheral device in data communication with the computing device via the data communication port;
providing a virtual representation of the peripheral device within the three dimensional virtual environment;
receiving an input signal from a user via the input port, the input signal indicative of user interaction with the virtual representation of the peripheral device;
providing data to the peripheral device in accordance with the input signal.

2. A method according to claim 1 comprising:
disposing the virtual representation of the peripheral device at a location within the three dimensional virtual environment corresponding to an actual location of the peripheral device.

3. A method according to claim 1 wherein the virtual representation of the peripheral device is generated with model data, the model data corresponding to a shape of the peripheral device.

4. A method according to claim 1 wherein the virtual representation of the peripheral device comprises a visual information indicative of a need for authorization in order to access the peripheral device.

5. A method according to claim 4 comprising:
upon receiving an input signal from the user, requesting authorization data;
upon verification of the authorization data, modifying the virtual representation of the peripheral device such that it is no longer indicative of a need for authorization in to access the peripheral device.

6. A method according to claim 1 comprising:
providing virtual representations disposed within the three dimensional virtual environment, the virtual representations corresponding to a plurality of software applications available for execution by the computing device.

7. A method according to claim 1 wherein the three dimensional virtual environment corresponds to a real working space of the user.

8. A method according to claim 7 wherein the virtual environment additionally comprises elements outside the users immediate workspace.

9. A method according to claim 8 wherein the user is inhibited from manipulating elements outside the users immediate workspace.

10. A method according to claim 9 wherein the three dimensional virtual environment corresponds to computing resources of a business and the user is affiliated with the business.

11. A method according to claim 8 comprising:
providing a second computing device comprising a second display and a second data communication port;
establishing a data communication between the first computing device and the second computing device via the second data communications port;
providing second image data to the second display, the second image data supporting a user interface that provides images corresponding to a second three dimensional virtual environment, the second three dimensional virtual environment presented in accordance with data provided via the second data communications port such that second three dimensional virtual environment shares at least a common element with the first three dimensional virtual environment.

12. A method according to claim 11 comprising:
providing a user input signal to the user input port, the user input signal indicative of manipulating a common element in the first three dimensional virtual environment;
providing data indicative of the manipulation of the common element from the first computing device to the second computing device; and,
manipulating the common element in the second three dimensional virtual environment.

13. A method according to claim 1 comprising:
determining a location of a viewpoint within the three dimensional virtual environment;
receiving a second input signal from the user via the input port, the second input signal for changing the location of the viewpoint; and,
changing the location of the viewpoint in dependence upon the second input signal.

14. A computing device comprising:
a memory for storing data, at least a portion of the data relating to a three dimensional virtual environment and selectable elements provided within the three dimensional virtual environment;
a user input device for receiving user input signals, the user input signals corresponding to a movement of a viewpoint and selection of elements within the three dimensional virtual environment;
a data communication port in communication with a peripheral device, the data communication port for receiving peripheral device data;
a processor for generating image data in dependence upon the three dimensional virtual environment, the viewpoint and the peripheral device data; and,
a display for displaying the image data.
